(19) United States
(12) Patent Application Publication
(10) Pub. No.: US 2007/0271596 A1
(43) Pub. Date: Nov. 22, 2007

(54) Security, storage and communication system

(76) Inventors: David Boubion, Tampa, FL (US); Peter Rung, Lutz, FL (US); Mary Claire Ryan, Burr Ridge, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/714,535

(22) Filed: Mar. 5, 2007

Related U.S. Application Data
(60) Provisional application No. 60/778,727, filed on Mar. 3, 2006.

(51) Int. Cl. G06F 15/16

(52) U.S. Cl. 726/3

(57) ABSTRACT

A secure system includes a user authentication device including memory, a microCPU, an authentication factor input and a communication port. The authentication device interacts with a securely monitored device including an identification transmitter that broadcasts information. A user is granted access to receive the broadcast information from the securely monitored device through the user authentication device after the user is authenticated by the user authentication device. A method of receiving information from a secured a device comprises the steps of receiving information broadcast from a securely monitored device to a user authentication device that includes memory for storing information regarding one or more authentication factors, a microCPU, an authentication factor input and a communication port. A user is authenticated by inputting authentication factors into the user authentication device. If the user is authenticated the received broadcast information to the user.

### CROSS REFERENCE TO RELATED APPLICATIONS

The present application is a Continuation-in-Part Application of U.S. patent application Ser. No. unassigned, filed Feb. 6, 2007, which further claims the benefit of U.S. Provisional Application No. 60/771,204 filed Feb. 6, 2006, and 60/778,727 filed Mar. 3, 2006.

### TECHNICAL FIELD

The present subject matter relates generally to a data security, storage and communication system for preventing unauthorized access to physical or electronic assets. More specifically, the present invention relates to a data security, storage and communication system using a portable authentication device for securely monitoring and reading the content of a secured asset.

### BACKGROUND

As an example, in the packaging, shipping, transportation and tracking industries, there is a need for accurately and securely monitoring shipments in real time. For example, when shipping a package, a shipper may benefit from real time tracking of the package's location, monitoring the physical status of the package (e.g., has the seal been broken) or monitoring the procedural status of the package (e.g., the package is being processed for shipment), or being able to create time or location stamps at designated intervals.

Therefore, a need exists for a system and method in which the integrity of both the object (e.g., the data) and subject (e.g., the user) is preserved in the process of authentication and verification.

### SUMMARY

As used herein, authentication is the act of establishing or confirming someone's or something's identity. For example, authentication of an object may be defined as confirming its state of existence. Authenticating an object may further include verifying that its source or origin is trustworthy. Authentication of a person may be defined as verifying that person's identity.

As used herein, an authentication routine is a process of authentication that may depend upon one or more authentication factors. As a non-limiting example, an authentication routine may include confirming something or someone's characteristics and/or data match a tabulated and/or stored value.

As used herein, an authentication factor is a piece of information used to verify identity or status for security purposes, and may be represented in any of the following forms: (1) who the user is—e.g., biometrics; (2) what a user has—e.g. a token or key; (3) what a user knows—e.g., social security number, a password, birth location; (4) where the user is—e.g., a GPS location; and (5) when the user is—e.g., time on the Greenwich Mean Time clock. Biometrics is an example of an authentication factor directed to determine who is being authenticated. Authentication factors can be used to authenticate who, what, where and when.

As used herein, symmetric authentication refers to a one-way authentication routine; typically from a person to an authenticating device or from an authenticating device to a secured device.

As used herein, asymmetric authentication refers to a two-way authentication routine; typically between an authenticating device and a secured device.

As used herein, biometrics refers to physical characteristics that produce a value that is exclusive to an individual's identity, such as, for example, fingerprints, vocal patterns, eye retinas and irises, facial patterns, hand measurements, vein patterns, DNA, etc.

As used herein, communication protocol refers to but is not limited to internet protocol (IP), radio frequency identification (RFID), Bluetooth, infrared (IR), magnetic swipe, smart card, wireless local area network (WLAN), voice over internet protocol (VoIP), Wi-Fi, Wi-Max, GSM/GPRS, GPS, CDMA, EvDO, TDMA (utilizing SIMM and USIMM platforms), short message service (SMS), multi media service (MMS), Universal Mobile Telecommunications System (UMTS), High Speed Downlink Packet Access (HSDPA)/High-Speed Uplink Packet Access (HSUPA) and general purpose interface (GPIO), and may employ software-defined radio (SDR) technology.

As used herein, an identification transmitter is an electronic identification communication device that broadcasts information regarding the status of the object to which it is associated. As used herein, a transponder is understood to be one embodiment of an identification transmitter. The broadcast may be active (e.g., always on), passive (e.g., must be triggered to operate) or pulsating (e.g., alternating periods of activity and inactivity). An identification transmitter may include a processing device, such as a microCPU, or it may be a static component. A non-limiting example of an identification transmitter is an RFID device.

As used herein, RFID device refers to a radio frequency activated tag, lock (digital or mechanical), tape, ribbon, or any other type of radio frequency device that is deployed as a digital communicator (transponder) with the object it is deployed to lock or monitor after it has received the proper authentication and identification information needed to instigate a command on/off and/or an activation/deactivation process. RFID systems use many different frequencies, including but not limited to low-frequency (around 125 KHz), high-frequency (13.56 MHz) and ultra-high-frequency or UHF (860-960 MHz) as well as microwave (2.45 GHz).

As used herein, GPRS device refers to a device that enables General Packet Radio Service (GPRS) for mobile data service available to users of GSM and IS-136 mobile phones. Data transfer that is packet-switched means that multiple users can share the same transmission channel, only transmitting when they have data to send.

As used herein, software-defined radio (SDR) refers to a radio communication system which can tune to any frequency band and receive any modulation across a large frequency spectrum by means of a programmable hardware which is controlled by software, thereby allowing for continuity in changing radio protocols during any communication transmission.

As used herein, a communication base refers to any type of communication hub or router that is used to relay communication from one device to another. A communication base may conform to prevailing terrestrial and maritime conditions that predicate the type of communication protocol to use. A communication base may be, but is not limited to, a portable satellite dish that relays a communication it has received locally to a distant location via an associated satellite in order to mitigate the communication disparities that may otherwise exist.

As used herein, multi-factor authentication is the use a plurality of authentication factors within an authentication routine. For example, any number of the following classes of authentication factors may be used in part or in totality in an authentication routine. For example, a multi-factor authentication routine for a person may include determining more than one of the following: (1) who the user is—e.g., biometrics; (2) what a user has—e.g. a token, dongle, or key; (3) what a user knows—e.g., social security number, a password, birth location; (4) where the user is—e.g., a GPS location; and (5) when the user is—e.g., time on the Greenwich Mean Time clock. The more authentication factors utilized, the higher confidence and security of authentication is achieved. Therefore, a higher level of security may be achieved by using multi-factor authentication.

Encryption is the process of obscuring information to make it unreadable without special knowledge of the seed. The term random seed, seed or seed state is a number (or vector) used to initialize a pseudorandom number generator. Encryption is used to protect data information and communication pathways to achieve high levels of privacy and secrecy. Strong encryption has emerged from government agencies into the public domain as part of international standards activities. It is used in protecting systems such as Internet e-commerce, mobile telephone networks and bank automatic teller machines and more. Encryption is also used in digital media copy protection, protecting against illegal copying of media, reverse engineering, unauthorized application analysis, and software piracy. Encryption can be used to ensure secrecy, but additional techniques are required to make communications secure. For example, communications can be secured by requiring verification of the integrity and authenticity of a message, e.g., by using message authentications codes (MAC) or digital signatures.

Wireless authentication and encryption allows the transmission of secure information over public, private and government wireless networks for executing a secure transaction, e.g., adding information to a system, acknowledging a systems or network event, or accessing a secure physical location such as a safe. One system and/or method for providing wireless authentication and encryption is based on an enhancement to Near Field Communications (NFC), as defined in ISO 14443. For example, this standard may be enhanced by requiring multiple authentication factors and utilizing various encryption methods, as described herein. Wireless authentication and encryption enables the use of wireless devices, including but not limited to a USB with a microCPU and wireless antenna, mobile communications devices such as mobile phones, smart phones, cell phones, smart Personal Digital Assistants, or any other portable wireless devices, for the purposes for the highly secure: transactions; information delivery; alert notifications; multi-media transmission; and value storage these portable devices as described herein. Stored value may be defined as but not limited to: encryption keys; user credentials; monetary units; official government documentation; payment transaction information; all forms of multi-media; personal documentation; legal documentation; and health information.

As used herein, the term intelligent token refers to flash, fob, dongle, token, and/or biometric devices including a microCPU configured to authenticate the identity of a user.

As used herein, the term secured intelligent token refers to an intelligent token further including software and/or hardware encryption built into the intelligent token for optimal security of the stored and/or communicated data. A secured intelligent token is one example of an authentication device, as used herein.

As used herein, protected information refers to data that is secured from access by unauthorized individuals or devices. For example, protected information may be password protected and/or encrypted.

As used herein, the term access key(s) refers to a secured communication mechanism to transmit a secured command to or between one or more devices to open or shut (e.g., lock or unlock, encrypt or decrypt, etc.) communications between the devices. For example, access keys may be, but are not limited to any one or more of the following, whether used independently or in any combination thereof: a key, a public key, a private key, a public and private key pair, a secret key, an encryption key, a high-grade key, a random key, a random generated key, a password, an encrypted value, a salt, a MAC, a digital signature, a credential, a certificate, an algorithm, a symmetric key algorithm, an asymmetric key algorithm, a cipher, block ciphers, stream ciphers, a code, a cryptographic hash, or any other similar data obfuscation procedure.

The present subject matter relates generally to a data security, storage and communication system using a portable authentication device for securely monitoring a secured asset. The secure system may be embodied in a user authentication device, which communicates with an associated securely monitored device. The user authentication device includes a memory, an authentication factor input device, such as, but not limited to a biometric input device, bundled with stand alone applications and/or an independent operating system.

In one embodiment, the secure system may include a user authentication device including memory for storing information, including one or more authentication factors, a microCPU, an authentication factor input and a communication port; and a securely monitored device including an identification transmitter that broadcasts information, wherein a user is granted access to receive the broadcast information from the securely monitored device after the user is authenticated by said user authentication device. In such an embodiment, the authentication device functions as a reader of the identification transmitter, which may be an RFID transmitter. Thereby, the authentication device functions to authenticate the user and further to read and acquire information from the secure device.

As further described herein, the user authentication device preserves the integrity of the user and the secured device preserves the integrity of the secured object or data. The secure system may be configured to accommodate any number of users, user authentication devices and securely monitored devices and can be configured to operate as a one-to-one system, a one-to-many system, a many-to-one system or a many-to-many system. The security and communication system may further include a remote administration system, for example, a server, to manage all aspects of the system including managing and maintaining the systems, networks, facilities, and information from a central location.

In one example, the authentication device may be a mobile, hand-held, remote control housing a biometric finger print scanner including flash memory and an imbedded independent operating system (microCPU) with wireless communication. The securely monitored device may be, for example, a container, vault or other enclosure that may be sealed and locked. When the authentication device is in communication with its associated securely monitored device (unilateral or bi-lateral communication), the authentication device seeks the operator's fingerprint for authentication. Proper authentication allows the user to receive communications from, or initiate communications with, the securely monitored device. An authorized user may further complete a series of encrypted challenges and responses via the authentication device in order to send a command from the authentication device to the securely monitored device, for example, to open an electronic lock. Accordingly, the securely monitored device (e.g., enclosure) may only be opened by a registered user via the authentication device. If the enclosure is opened without authorization, communication of the security breach may be immediately sent to the owner or other trusted party.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF DRAWINGS

The drawing figures depict one or more implementations in accord with the present concepts, by way of example only, not by way of limitations. In the figures, like reference numerals refer to the same or similar elements.

FIG. 1 is a schematic illustrating a secure system utilizing a physical connection between a user authentication device and a secured device.

FIG. 2 is a schematic illustrating a secure system utilizing a wireless connection between a user authentication device and a secured device.

FIG. 3 is a schematic illustrating a secure system that includes ID authentication and verification, monitoring, tracking, alerting, time stamping, and multi-communication protocol transmission of the same in conjunction with a transponder that is employed to safeguard the integrity of a container and is positioned on the exterior of the container.

FIG. 4 is a schematic illustrating a secure system that includes ID authentication and verification, monitoring, tracking, alerting, time stamping, and multi-communication protocol transmission of the same in conjunction with a transponder that is employed to safeguard the integrity of a container and is positioned within the container.

### DETAILED DESCRIPTION OF PREFERRED EMBODIMENT

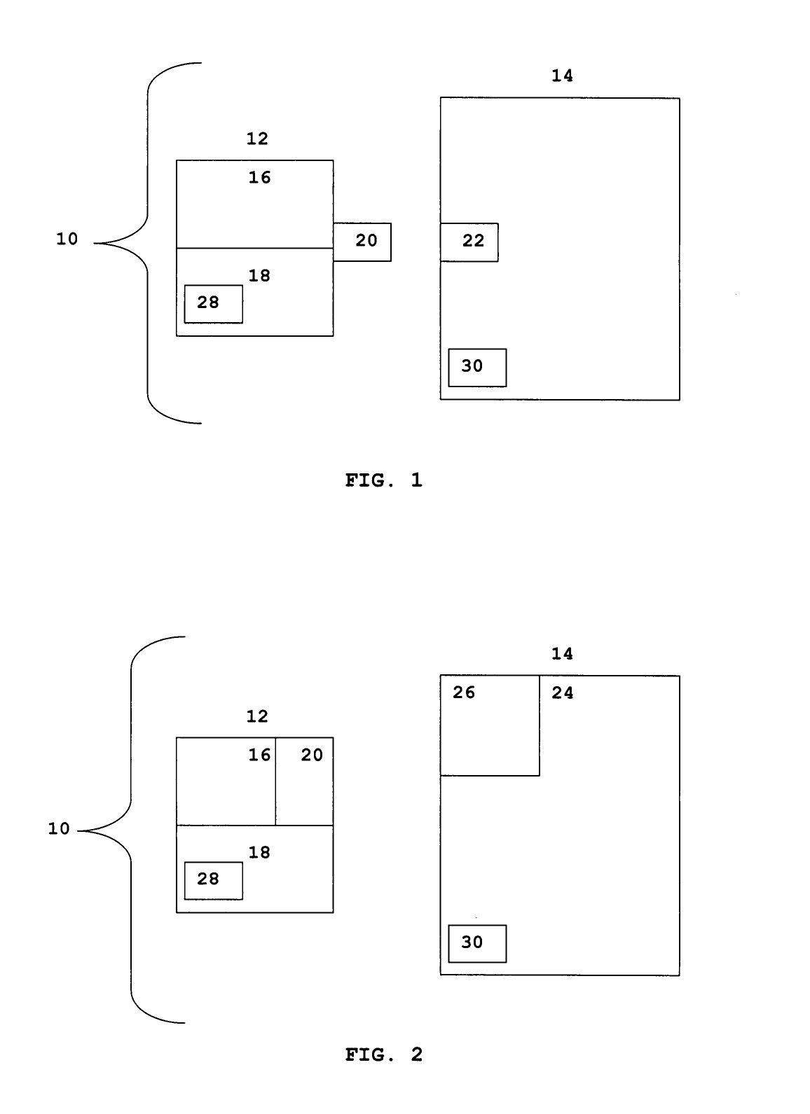

FIG. 1 illustrates a secure system 10 wherein a user authentication device 12 including a microCPU 28 cooperates with a secured device 14 having a microCPU 30 in order to secure access to the secured device 14. In the embodiment shown in FIG. 1, the secured device 14 will not operate until the user authentication device 12 authenticates a user, the secured device 14 authenticates the user authentication device 12 and any required access keys are communicated to the secured device 14. It is understood that the logic processing described herein with respect to the user authentication device 12 and the secured device 14 is carried out by their respective microCPU's 28 and 30 and the software and/or operating systems programmed thereto. Accordingly, the description of access keys being communicated to the secured device can be understood as access keys being communicated to the microCPU 30 of the secured device 14. It is further understood that the microCPU's 28 and 30 described herein may operate actively and/or passively to optimize operating conditions, including, for example, power management and battery life.

The communication pathway illustrated in FIG. 1, described further below, is a physical connection between the user authentication device 12 and the secured device 14. However, it is understood that any of the embodiments of the examples used herein may incorporate physical and/or wireless connections. Moreover, it is understood that the user authentication device 12 and the secured device 14 may communicate unilaterally and/or bilaterally.

FIG. 2 illustrates a secure system 10 wherein a user authentication device 12 cooperates with a secured device 14, such as, for example a lock 24, in order to secure access to a secured asset. In the embodiment shown in FIG. 2, the lock 24 will not open until the user authentication device 12 authenticates a user, the lock 24 authenticates the user authentication device 12 and any required access keys are communicated to the lock 24. The lock 24 and the assets secured by the lock may be physical, electronic or any combination thereof. The communication pathway illustrated in FIG. 2 is a wireless connection between the user authentication device 12 and the secured device 14. However, as described above, it is understood that any of the embodiments of the examples used herein may incorporate physical or wireless connections.

As shown in FIGS. 1 and 2, the user authentication device 12 includes a memory 16, bundled application software/firmware, an authentication factor input device 18, a communication port 20 and a microCPU 28 embedded within the user authentication device 12. The authentication factor input device 18 may be, for example, a user credentials input, an intelligent token and/or a biometric input. As shown in FIG. 1, the user authentication device 12 may be embodied in a dongle. Alternatively, the authentication device 12 may be embodied in any physical form, such as, for example, a token. The memory 16 may be any type of memory, including, but not limited to, the most minute micro memory capacity, flash, SD & CD flash technologies, hard disk drives and SIMMS. The authentication factor input device 18 may be, but is not limited to, for example, a biometric fingerprint scanner. It is contemplated that the authentication factor input device 18 may be any type of authentication factor input device 18. The microCPU 28 of the user authentication device 12 shown in FIG. 1 may include, but not be limited to, 64-256 bit hardware encryption. Alternatively, the microCPU 28 may use any type of encryption to secure and protect the information stored therein.

It is further contemplated that the authentication factor input device 18 used in the example illustrated in FIG. 1 is merely one form of input that may be utilized with the secure system 10. For example, any form of authentication information may be utilized in place of the biometric data, for example, a password, certificate, access code, etc. Similarly, the authentication factor input device 18 may be any type of input device, such as, for example, a keypad or touch screen.

The secured device 14 shown in FIG. 1 has a microCPU 30 and a communication port 22. In a PC logon routine, for example, the secure system 10 provided herein acts in front of the PC's BIOS and operating system and prevents any access thereto without proper authentication. It is understood that the secure system 10 may be implemented in just about any electronic device.

As illustrated in FIGS. 1 and 2, communication between the user authentication device 12 and the secured device 14 may include three radio types: personal area (PAN) (such as, for example, Bluetooth™), local area (LAN) and wide area (WAN), as well as the area and linear imagers integrated into the handheld device as well as be accomplished using any communication protocol, including, but not limited to, internet protocol (IP), radio frequency identification (RFID), Bluetooth, infrared (IR), magnetic swipe, smart card, wireless local area network (WLAN), voice over internet protocol (VoIP), Wi-Fi, Wi-Max, GSM/GPRS, GPS, CDMA, EvDO, TDMA (utilizing SIMM and USIMM platforms), short message service (SMS), multi media service (MMS), Universal Mobile Telecommunications System (UMTS), High Speed Downlink Packet Access (HSDPA)/High-Speed Uplink Packet Access (HSUPA) and general purpose interface (GPIO), and may employ software-defined radio (SDR) technology. The interface connectivity between the communication ports 20 and 22 may be provided by any interface, including, but not limited to, radio frequency (RF), IR, magnetic swipe, USB, Firewire, common access card (CAC) and serial or parallel interfaces. Encryption of the communication between the devices may be software or hardware based and may be employed at both the “master and/or slave” level.

In the examples shown in FIG. 1, the user authentication device 12 and secured device 14 communicate using a USB 2.0 interface. Accordingly, as shown in FIG. 1, the communication port 20 of the user authentication device 12 is a male ended USB connector and the communication port 22 of the secured device 14 is a female ended USB connector. The communication ports 20 and 22 may take various physical forms as required by the type of interface implemented.

A user enrolls its authentication factors in the user authentication device 12 by way of an enrollment process wherein the user authentication device 12 captures certain data and stores the data encrypted, or otherwise protected, in the memory 16 of the user authentication device 12. For example, the authentication device shown in FIG. 1 may enroll a user's biometrics. The enrollment process may be used to register the user as an authorized user to access the microCPU 28. Moreover, the enrollment process may be used to designate the administrative privileges granted to the user, for example, by designating the user as the primary user, owner, master or administrator of the secured device 14. In the enrollment process, commands are given to the microCPU 28 that is in shut-off mode until an authorized user is verified. In shut-off mode, there is no access to the microCPU 28. Depending on the user configuration of the microCPU 28, multiple users may be authorized via one or more enrollment processes.

In a unlocking routine utilizing the secure system 10, for example, there may be a “pre-logon” routine wherein a locking device (e.g., an RFID device associated with a microCPU 30 that secures the doors of a container on a ship using an electronic locking mechanism) functions as the secured device 14 once an initial enrollment process has been completed with an associated user authentication device 12. Accordingly, an authorized user may perform a pre-logon authentication routine to securely unlock and access the locking device (microCPU 30 in the RFID device) utilizing the secure systems 10 shown in FIGS. 1 and 2. The locking device will not deactivate its locked status until the proper access keys are received from the user authentication device 12 after proper authentication and validation with the microCPU 30 of the secured device 14. The pre-logon authentication routine ensures that the keys and commands given to the microCPU 30 are provided by an authorized user and prevents history traces of the protected access data from being stored in the secured device 14. Because the keys and authentication factors, for example a fingerprint template, are held in the user authentication device 12 separate from the microCPU 30 of the secured device 14 and are not accessible due to the encryption or other protection of the data, the user authentication device 12 functions as a firewall for access to the container doors protected by the RFID device. The pre-logon authentication routine may include, for example, interfacing the user authentication device 12 with the microCPU 30 of the secured device 14 and scanning the user's fingerprint into the user authentication device 12. The pre-logon routine may further include other pre-logon authentication actions, including, for example, responding to additional security challenges, such as a series of encrypted challenges, user credentials or passwords presented by a secured encryption key posited in the microCPU 30, thereby creating another level of security.

When the user authentication device 12 receives authentication factor input from a user through the authentication factor input 18, the user authentication device 12 compares the incoming data to the authentication factor data stored in its memory 16. If the incoming authentication factor data matches stored authentication factor data for an authorized user, the user authentication device 12 transmits the access keys associated with the recognized user through the communication port 20 of the user authentication device 12 to the communication port 22 of the secured device 14. Upon receiving the appropriate access keys, the secured device 14 grants access to the user.

The secure system 10 shown in FIG. 1 can be used to connect computer peripherals and devices and allows for encryption and decryption of data, speech, optics and multimedia communications between different devices, for example, a USB mass storage device, a mobile phone, an IP phone, a camera, or another electronic device. The encryption and decryption between devices, utilizing multi-factor authentication, can be conducted without the need of a separate computer, but rather between two communicating microCPU's, for example microCPU 28 and microCPU 30. For example, a token functioning as a user authenticating device 12 may communicate with a cell phone functioning as a secured device 14. In another example, communicating cell phones can function as both user authentication devices 12 and secured devices 14 with respect to each other.

Similar to the example shown in FIG. 1, the secure system 10 can further be employed within a network, wherein access to the network or secured servers therein may be reserved for a limited number of individuals, for example, high-level executives.

As described above, FIG. 2 illustrates a secure system 10 wherein a user authentication device 12 cooperates with a microCPU 30 regulating the security of a lock 24 functioning as a secured device 14. The lock 24 will not open until the user authentication device 12 authenticates a user, communicated the correct access keys to the microCPU 30, the microCPU 30 of the lock 24 authenticates the user authentication device 12 and any required access keys are communicated to the lock 24.

The lock 24 shown in FIG. 2 includes a microCPU 30 and a communication port 26 for receiving a signal from the user authentication device 12. As shown in FIG. 2, the communication port 26 is an RF port. As further shown in FIG. 2, the lock 24 via its microCPU 30 may separately communicate with management control software, for example, in a company directory, for remote programming and monitoring of the lock 24. The additional layer of communication embodied in the microCPU 30, including another authentication factor, increases the redundancy factor for layer security.

The user authentication device 12 shown in FIG. 2 may be the same device shown in FIG. 1. However, in the embodiment shown in FIG. 2, the communication port 20 of the user authentication device 12 is an RF transmitter.

In one contemplated embodiment, the secure system 10 shown in FIG. 2 may be implemented in industrial areas where it is preferable to minimize physical contact between people and the environment. For example, the secure system 10 may be implemented in a hazardous chemical waste facility. In a hazardous chemical waste facility, the lock 24 may be contaminated by spores of hazardous material. With the remote communication between the user authentication device 12 and the lock 24, transmission of the hazardous material between the lock 24 and an authorized user can be minimized.

Further, in embodiments where hazardous waste contamination is not a danger, the secure system 10 shown in FIG. 2 can be supplemented by a separate input device, such as a wall mounted keypad, which may be used to initialize communication between the user authentication device 12 and the lock 24 or to provide additional challenge responses between microCPU 28 and microCPU 30.

Both devices should provide no feedback to the person attempting to be authenticated, to indicate that the authentication failed, since such feedback conveys information that would benefit an illegitimate person.

When a technical design requires that there be a secured communication dialogue between two separate objects or devices, then a secured and bilateral communication is made between said objects utilizing an asymmetric challenge response. A challenge response dialogue is created to compare and validate stored and encrypted information, including the encryption keys, values, stored message, voice data, and including but not limited to streaming video.

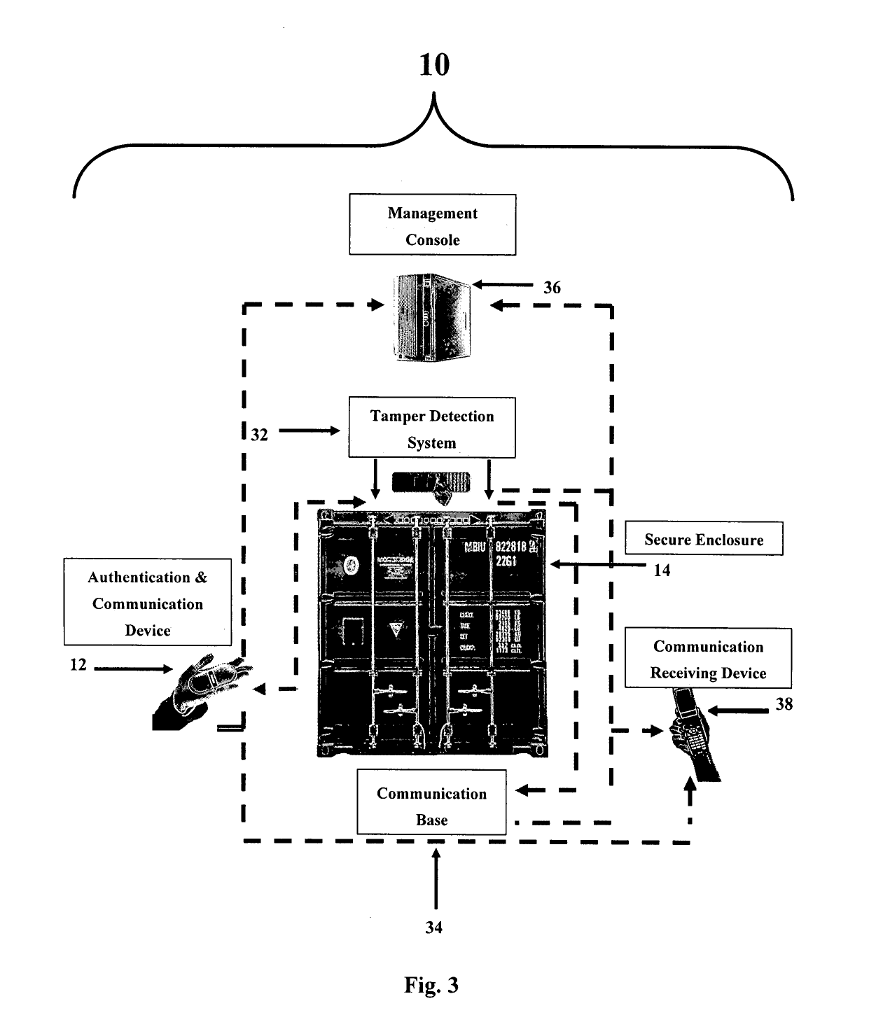

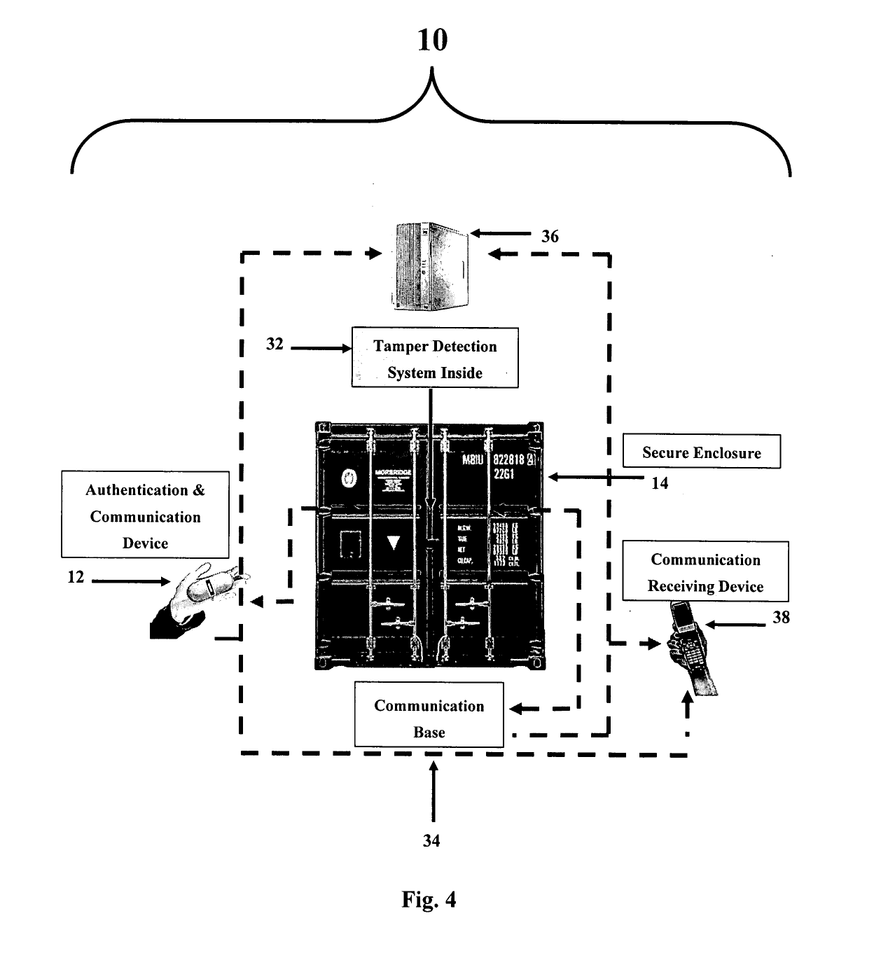

FIGS. 3 and 4 illustrate embodiments of the secured system 10 including an authentication device 12, an associated secure enclosure 14, a management console 36, a communication receiving device 38, a tamper detection system 32 and a communication base 34. The tamper detection system 32 shown in FIGS. 3 and 4 is a securely monitored device, as described further herein. A securely monitored device is understood to be a subset of the secured devices 14 described above.

The systems 10 shown in FIGS. 3 and 4 provide for private and secure transportation of goods and further provide rapid authorization and verification of certified users and execution of operational functions from great distances or close range depending upon the communication protocols utilized. For example, long range operation of the system may be provided using GPS, GPRS, SIM and USIM applications, to name just a few. Alternatively, short range operation of the system may be provided using RFID, Bluetooth or IR protocols. Any communication protocol may be employed, including, but not limited to, internet protocol (IP), radio frequency identification (RFID), Bluetooth, infrared (IR), magnetic swipe, smart card, wireless local area network (WLAN), voice over internet protocol (VoIP), Wi-Fi, Wi-Max, GSM/GPRS, GPS, CDMA, EvDO, TDMA (utilizing SIMM and USIMM platforms), short message service (SMS), multi media service (MMS), UMTS, HSDPA/HSUPA, and general purpose interface (GPIO). It is contemplated that any combination of these or any other communication protocols may be employed with or without the use of an SDR system by any of the authentication device 12, the associated secure enclosure 14, the management console 36, the communication receiving device 30, the tamper detection system 32 and the communication base 34 according to the operational requirements of the system 10.

In the embodiment shown in FIGS. 3 and 4, the authentication device 12, for example, may be a mobile, hand-held, remote control housing a biometric finger print scanner 18 and flash memory 16 with an imbedded independent operating system and wireless communication port 20.

The secure enclosure 14 shown in FIGS. 3 and 4 may be a container for transporting goods. In other examples, the associated secure enclosure 14 may be a container, a vault or any other enclosure, whether portable, semi-permanent or permanent.

As shown in FIGS. 3 and 4, the secure enclosure 14 includes a tamper detection system 32. The tamper detection system 32 shown in FIG. 3 may include, as an example, a pair of linear directed active RFID or GPRS devices adapted for sensing the position of the container doors. The tamper detection system 32 shown in FIG. 4 may include a physical digital lock located inside of the secure enclosure 14.

Additionally, the secure enclosure 14 shown in FIGS. 3 and 4 includes a communication base 34 for sending and or storing status and alarm condition information utilizing but not limited to RFID, GPS, UMTS, HSDPA/HSUPA, or GSM/GPRS technologies. Stored alarm condition information relayed to the management console 36 may be used for forensic analysis. In addition to the examples shown in FIGS. 3 and 4, the secure enclosure 14 may include any number or type of logical and physical security systems.

The communication base 34 may include the software and hardware required to communicate with the authentication device 12, the secure enclosure 14, the management console 36, the communication receiving device 38 and the tamper detection system 32. In order to reduce system costs, it may be advantageous to utilize a single communication base 34 to communicate with a plurality of secure enclosures 14. For example, a shipping vessel might include hundreds or thousands of secure enclosures 14 that each communicates with a single communication base 34.

The management console 36 shown in FIGS. 3 and 4 is a management console for the management of security thresholds and access controls, and for managing and maintaining the system 10, including the networks, facilities and information transmitted therein. The management console 36 may be adapted to manage all aspects of the system 10 including enrollment of authentication devices 12 and secure enclosures 14, protection of authentication devices 12 and secure enclosures 14 and communication to, from and between the authentication devices 12, the secure enclosures 14, the communication base 34 and the communication devices 38. In the embodiment shown in FIG. 3, the management console 36 is a remote server.

One or more authentication devices 12 and secure enclosures 14 may be registered in the management console 36 for use in the system 10. The authentication devices 12 and secure enclosures 14 may be configured in a “one to many,” a “many to one,” a “many to many” or any other configuration. Similarly, communication devices 38, such as cell phones, PDAs, etc. may be registered in the management console 36 for use in the system 10 and may be associated with one or more authentication devices 12, tamper detection systems 32, communication bases 34 and secure enclosures 14 in a “one to many,” a “many to one,” a “many to many” or any other configuration.

In the examples shown in FIGS. 3 and 4, the secure enclosure 14 may be loaded, sealed, dated and time stamped by an authenticated user. The secure enclosure 14 may then only be properly opened by a registered authentication device 12. As an example, if the secure enclosure 14 is opened without proper authorization, communication of the security breach may be immediately sent to the registered communication receiving device 38 of the owner or other registered/trusted party.

For example, as shown in FIG. 3, the tamper detection system 32 includes a pair of active RFID or GPRS devices that communicate using set-position programming. The tags may be activated and deactivated using a registered authentication device 12. The authentication process in 12 may include a biometric reading as well as a series of encrypted challenges and responses. The authentication device 12 is now open to send a command activate (e.g., set in lock status) to the tamper detection system 32. Once activated, if the positions of the tags are altered without biometric authentication of registered user using an authentication device 12, an alarm condition is activated and a signal is transmitted to the communication base 34, which receives the alarm condition information and further transmits the information to the management console 36 and communication devices 38, directly or indirectly. The alarm condition information may further be stored and utilized by the management console 36.

Accordingly, in the examples of the system 10 shown in FIGS. 3 and 4, a user may validate himself/herself as a registered user of the system 10 using the authentication device for biometric fingerprint verification. If successfully validated by the secure enclosure 14 and/or the management console 36, the tamper detection system 32 and the communication base 34 recognize the authorized action and do not signal, transmit and store an alarm condition. However, the authorized action may itself be signaled, transmitted and stored. For example, the authorized opening of the enclosure may be recorded in the management console 36 and the event data may be transmitted to registered communication devices 38 associated with the secure enclosure 36 in real time. If the tamper detection system 32 shown in FIGS. 3 and 4 senses unauthorized access or other tampering, an alarm signal may be programmed to be relayed to the communication base 34, management console 28 and/or registered communication devices 38, concurrently.

It is understood that in the examples provided with reference to FIGS. 3 and 4, the authentication device 12 may function as a reader of the identification transmitter (e.g., the tamper detection system 32) and that the identification transmitter may further be provided to transmit other information, for example, information used in multifactor authentication or any other tracking, monitoring or identification information.

The following non-limiting examples are provided to further demonstrate secured systems 10 according to the present invention.

The authentication processes between the authentication device 12 and the secured device 14 in FIGS. 1 and 2, as well as other secure devices or secure relay devices, namely the tamper detection system 32, the communication base 34, the management console 36 and the registered communication device 38 in FIGS. 3 and 4, involves an exchange of messages between the user authentication device 12 and the secured device 14. Each message in this exchange is encrypted with the Advanced Encryption Standard (AES), using a 256-bit encryption key. This level of encryption has been approved by the National Security Agency for all levels of unclassified and classified information, including Top Secret information.

The implementation used for this encryption, uses a password whose length is between 48 and 63 characters. For example, identical password values must be pre-configured in the user authentication device 12 and secured device 14 prior to the authentication process. The password, along with a randomly generated 16-byte value, called the salt, is used to generate a 32-byte (256-bit) AES key. The algorithms used to generate the salt and the key, are defined by RFC 2898.

In addition to AES encryption, each message is digitally signed with a 10-byte Message Authentication Code (MAC). The MAC is used to verify that the encrypted message received is indeed the message that was sent. That is, it validates that the content of the message has not been altered. Further more, it validates that the message was encrypted with the specific password. That is, upon receipt, the MAC value will not validate if either the message had been altered, or if a different password was used to encrypt the message.

When a message is sent, from either the authentication device 12 or the secured device 14 in FIGS. 1 and 2, as well as other secure devices, namely the tamper detection system 32, the communication base 34, the management console 36 and the registered communication device 38 in FIGS. 3 and 4, the following is an example of steps that may occur:
1. In the originator of the message (the sender)
   a. A random salt value is generated.
   b. The pre-configured password and the salt are used to generate a 256-bit length key.
   c. The message is encrypted with AES, using the 256-bit length key.
   d. Using the secret password and the message, a 10-byte MAC value is generated.
   e. The salt value, the encrypted message and MAC value are sent to the destination.
2. In the destination (the receiver)
   a. The received salt value and the pre-configured password are used to generate a 256-bit length key.
   b. This key is used to decrypt the message.
   c. The password and message are used to generate a MAC value.
   d. This generated MAC value is compared to the received MAC value. If they are identical, the received message is valid. Otherwise the received message is deemed invalid.

Though the above section is based on AES, the Challenge Response Protocol is not limited to AES. Many other encryption algorithms can be used. One such algorithm is Blowfish. Unlike AES, Blowfish starts with a key value (instead of a password), ranging from 32 to 448 bits in length. For more secure encryption, higher key lengths (128 and above) is recommended.

The Blowfish algorithm does not specify the use of a MAC, however MAC generation can easily be combined and used with Blowfish.

The Challenge Response message set consists of four messages. For example, the exchange is initiated from the user authentication device 12, which sends a Verification Request message to the secured device 14. Since the user authentication device 12, at this point, does not know that it is communicating with a trusted secured device 14, minimal information is sent with this message.

The secured device 14 receives this message, decrypts it and validates the MAC. If the message does not validate, or the decrypted message does not match the Verification Request command, then no response will be sent from the secured device 14 to the user authentication device 12. This lack of response is preferred over a negative response, as it provides no feedback to the suspect user authentication device 12.

It is possible that the user authentication device 12 is valid and that messages between the user authentication device 12 and secured device 14 have gotten out of sync, such that the secured device 14 is receiving this message out of context. To correct this problem, the person attempting authentication can remove and reinsert the user authentication device 12 from the USB port on the secured device 14, and begin the authentication process again. This action will synchronize the two devices.

If the MAC sent with the message is validated, and the message is recognized as a Verification Request, the secured device 14 will respond with a Verification Pending message. Again, this message is encrypted and sent with a MAC. At this point the secured device 14 can view the user authentication device 12 as a trusted device, since it sent a message with a valid password. However, the person using the user authentication device 12 may not yet be trusted.

The user authentication device 12 receives the Verification Pending message, decrypts it and verifies the MAC. As before, if the MAC does not verify or the message content is not recognized as the Verification Pending command, then the user authentication device 12 does not respond to the secured device 14, and communication with the secured device 14 is terminated.

If the Verification Pending message is verified, then the user authentication device 12 to the secured device 14 with the Verification Information message. This message may contain the identification information of the person being verified (e.g. name, contact information, etc.). As always, this message is encrypted and sent with a MAC for validation.

After the secured device 14 decrypts and validates this message, the identity information may be used to verify that the person is indeed an authorized user of the secured device 14. In addition, the information can also be used to create an entry in a usage log in the secured device 14. If the person is not an authorized user, no response is sent back to the user authentication device 12. If the person is an authorized user, the secured device 14 will respond with the Verification Accepted message.

After the secured device 14 decrypts and validates this message, the identity information may be used to verify that the person is indeed an authorized user of the secured device 14. In addition, the information can also be used to create an entry in a usage log in the secured device 14. If the person is not an authorized user, no response is sent back to the user authentication device 12. If the person is an authorized user, the secured device 14 will respond with the Verification Accepted message.

As the messages are constructed in the user authentication device 12 (the Verification Request and Verification Information messages), before encryption, the bytes of the messages are summed. Prior to sending the Verification Information message, a byte whose value is the two's complement of the current sum, is added to that message. As a result, the sum of all bytes in these two messages will be zero.

When the secured device 14 receives the Verification Information message, it verifies that the sum of the bytes across both received messages is zero. If it is not, the authentication is not valid.

During the message exchange, when a message is not valid, no response message is sent. As a result the device could be left waiting infinitely. By contrast, each device should time out while waiting, if the expected response has not been received. A reasonable timeout of 1 or 2 seconds may be used.

While waiting for the Verification Pending or Verification Accepted messages, the user authentication device 12 could timeout. In that case, the user authentication device 12 should terminate communications with the secured device 14. It should not send messages to the secured device 14, nor accept messages received from the secured device 14.

The secured device 14 might also timeout, while waiting for the Verification Information message from the user authentication device 12. Upon such a timeout, the secured device 14 should terminate communications with the user authentication device 12.

The authentication, verification, and communication sequence described above is the same between the other secure devices, namely the tamper detection system 32, the communication base 34, the management console 36 and the registered communication device 38 in FIGS. 3 and 4.

In the examples provided above, it is understood that the user authentication device 12 function may be replaced with a communication device 38 (FIGS. 3 and 4) including an embedded verification unit microCPU 28 (FIGS. 1 and 2). It is further contemplated that the secured device 14 may be a container on a ship protected by a tamper detection system 32 which may include a microCPU 30 (FIGS. 1 and 2). It is also understood that in some embodiments, the communication device 38 and the secured tamper detection system 32 may hold the same encryption algorithm and the same secret key, for example, key size 32 bytes. (ATA command uses 32 bytes.) Accordingly, another example is provided in which:

1) The communication device 38 sends a notification to the tamper detection system 32 that it wants to perform an authentication (in order to “open” the secured device 14). This may be called a “wake up.”

2) The tamper detection system 32 sends a challenge string to the communication device 38 (this is the “challenge”).

3) While sending the challenge, the tamper detection system 32 uses encryption with the secret key to calculate the expected reply from the user authentication device 12. There is no need to save the challenge string by either the communication device 38 or the tamper detection system 32. The sending unit can perform encryption for each byte transmitted and the receiving unit can perform encryption byte for byte as they are received.

4) The communication device 38 receives the challenge and uses encryption with the same secret key to calculate the reply.

5) The communication device 38 sends the reply to the tamper detection system 32.

6) The tamper detection system 32 checks the reply. If the reply has the expected value tamper detection system 32 will send a message to the communication device 38 confirming a successful authentication and “opens” its resources.

7) The communication device 38 can now access resources in the secured device 14.

In this example, the tamper detection system 32 has a Random Generator that produces a truly random “challenge string” (it must create random numbers each time it is initiated). The challenge string should be at least 128 bytes. The first “challenge string” after power up must be unique at each power up. In no case should it repeat the same “challenge string” or make them in a predictable sequence. Other restrictions may be out on the “challenge string” in order to make it harder to calculate the secret key.

Further, the size of the reply should be 16 bytes with the start value all zero. When the challenge string is encrypted byte for byte, the resulting byte values are added to the reply in the following way: reply[0], reply[1], reply[2], reply[3], reply[4], reply[5], reply[6], reply[7], reply[0], reply[1], reply[2], . . . , This makes it impossible to calculate the hidden key from the openly transmitted reply. Each of these 16 bytes will have a sum of 8 encrypted bytes individually. There will be an overflow in each of these bytes, but this doesn't matter as the receiving unit will have the same overflow, and the value will be exactly the same.

There is of course need for some kind of very simple primary protocol like STX and a code (some command) for “wake up”, “reply” and “authentication OK”, but there is really no need for CRC (a check sum, which is evaluated once the message is received) because the 16 bytes mentioned above have been canceled out to zero calculations as a correct reply is enough. If there is a CRC available, then it can be used anyway.

It is understood that the bilateral communication between devices can result in each user possessing a device that functions as both a user authentication device 12 and a secured device 14, or from communication device 38 to secured device 14, or communication device 38 to another communication device 38. That is, for example, if a secured and authenticated communications between cell phones is desired, a first user may have a cell phone that functions as a user authentication device 12 with respect to the first user and functions as a secured device 14 with respect to the second user's cell phone. Similarly, the second user may have a cell phone that functions as a user authentication device 12 with respect to the second user and a secured device 14 with respect to the first user's cell phone.

Another embodiment of the secure system 10 utilizes a mobile communications device for the purposes of predefined and prescreen access through security checkpoints such as an airline terminal, highly secured buildings, chemical facilities, and more. By pre-authenticating a person and providing the person's credentials as stored value on their mobile communicator bundled with the secured software/firmware, the user authentication device 12, the person, once authenticated on the mobile communicator, may initiate an encrypted wireless communications process as a security checkpoint, the secured device 14, verifying and positively identifying them for enhanced a speedy clearance through the security checkpoint.

By using an a communication device 38, for example, an authenticated user may employ robust and multi-tasking objectives by utilizing the communication device 38 with a central management console, whereby user credentials may be created and loaded into the communication device 38. This may be done by a secured communication dialogue between the communication device 38 and the central management console residing on a server. As such, updating, deleting, editing, and user profile and security threshold management may be conducted remotely and most likely monitored at a supervisory level. As an example, in the hospitality, entertainment, and gaming, industries the utilization of the communication device 38 may be employed for security, user policy, tracking and monitoring, as well as validating the credit worthiness of an individual. As an example, any container that transports money from the gaming floor to a bank vault may be fitted with this technology.

In yet another embodiment, the secure system 10 may be employed by the Coast Guard or other security personnel, whether governmental or private, in order to enroll and/or identify people in the field in real-time. In such an embodiment, a Coast Guard officer may employ his/her authentication device 12, which in this case may be fitted with a fingerprint biometric scanner 18, to use when boarding/surveying a ship, boat, or raft out at sea to determine the status of those on board. By requiring those on the ship, boat, or raft to enroll their fingerprint onto the scanner 18 of the authentication device 12, the fingerprint data (authentication factor) may be saved onto the memory 16 of the authentication device 12 to be compared to a pre-installed data base of known criminals or refugees in the memory 16, or be used to enroll them for the first time. The fingerprint data input into the authentication device 12 may also be communicated from the authentication device 12 to a secure device 14, such as a secure data base residing on a Coast Guard server, in near live time, as the fingerprint enrollment process is taking place. Communication with a secured device 14 enables access to a greater range of resources than might be available within the authentication device 12 itself.

Another embodiment could be a financial executive, healthcare physician, insurance executive, or a government official using a communication device 38 to connect to a PC, a secured device 14, in order to execute encrypted communication through a secured communication protocol. As an example, an investment banker may want to talk and send data to a very high profile client that demands absolute privacy. This may be undertaken by encrypting the data that resides in the communication device 38 or first retrieving the data that resides on the secured device 14 to be encrypted. Then creating an encryption key associated with that encrypted data to be sent via an encryption communication pathway or tunnel by way of a chat box embedded in a secured soft phone that resides and is executed from the communication device 38 itself. The investment banker not only sends encrypted data packets, but does so in encrypted communication as he/she is speaking to the client in an encrypted communication tunnel. If they want to see each other, then the same communication device 38 may be used to create a an encryption key that will be used to access a secured virtual safe room, where a secured video session may be initiated by those who have the right encryption key to enter it. Because the user has encrypted data and voice, he/she may also encrypt video streams for secured video conference. In this example, both users' communication device 38 is used to authenticate and communicate with the safe room, which in this case would be the secured devices 14.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A secure system comprising:
a user authentication device including memory for storing information regarding one or more authentication factors, a microCPU, an authentication factor input and a communication port; and
a securely monitored device including an identification transmitter that broadcasts information, wherein a user is granted access to receive the broadcast information from said securely monitored device through said user authentication device after the user is authenticated by said user authentication device.

2. The secure system of claim 1 wherein said communication ports communicate through a wireless connection.

3. The secure system of claim 1 wherein said microCPU includes software-defined radio capability.

4. The secure system of claim 1 wherein said identification information identifies the status of a monitored condition of the securely monitored device.

5. The secure system of claim 1 wherein said user authentication device is a stand alone battery powered device.

6. The secure system of claim 1 wherein said user authentication device communicates unilaterally with said securely monitored device.

7. The secure system of claim 1 wherein said user authentication device and said securely monitored device communicate bilaterally.

8. The secure system of claim 1 wherein the information broadcast from said securely monitored device is encrypted.

9. The secure system of claim 1 wherein said information stored in said memory of said user authentication device is encrypted.

10. The secure system of claim 1 wherein the broadcast information is received by said authentication device via a relay device.

11. The secure system of claim 10 wherein said relay device enables two way communication between said relay device and said authentication device.

12. The secure system of claim 1 wherein said relay device is communication base.

13. The secure system of claim 1 wherein a plurality of user authentication devices is associated with said secured device.

14. The secure system of claim 1 wherein a plurality of securely monitored devices are associated with said user authentication device.

15. The secure system of claim 1 wherein multiple users' authentication factors are stored within said user authentication device.

16. The secure system of claim 1 wherein said identification transmitter is a radio frequency identification transmitter.

17. A method of receiving information from a secured a device comprising the steps of:
receiving information that is broadcast from a securely monitored device that includes an identification transmitter that broadcasts information, wherein the information is received in a user authentication device that includes memory for storing information regarding one or more authentication factors, a microCPU, an authentication factor input and a communication port;
authenticating a user to use the user authentication device by receiving authentication factor input through the user authentication device and comparing the authentication factor input to authentication factor information previously stored in the user authentication device and/or database on a server; and
if the authentication factor input into the authentication device matches the authentication factor information stored in the user authentication device, authenticating the user authentication device to provide the received broadcast information to the user.

18. The method of claim 17 wherein said identification transmitter is a radio frequency identification transmitter.

19. The method of claim 17 wherein the broadcast information is received by said authentication device via a relay device.

20. The method of claim 19 wherein said relay device enables two way communication between said relay device and said authentication device.
